(19) United States
(12) Patent Application Publication
(10) Pub. No.: US 2001/0017656 A1
(43) Pub. Date: Aug. 30, 2001

(54) Internet camera system

(75) Inventors: Yoshiyuki Araki, Saitama-ken (JP); Kiyoshi Negishi, Saitama-ken (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/790,610

(22) Filed: Feb. 23, 2001

(30) Foreign Application Priority Data
Feb. 25, 2000 (JP) 2000-49250

(51) Int. Cl. H04N 5/232; H04N 7/14

(52) U.S. Cl. 348/211; 348/552; 348/14.09; 348/14.01

(57) ABSTRACT

An Internet camera system is provided with an Internet camera and a plurality of clients, each of which are connectable to a predetermined server on the Internet. The Internet camera includes an image capturing system that captures an image covering a relatively wide area, and a transmitting system that transmits the captured image to the server on the Internet. Each of the plurality of clients includes a downloading system that downloads the image from the predetermined server, a storage device that stored the downloaded image, an extracting system that extracts a desired part of the image stored in the storage device, and a display system that displays the part of the image extracted by the extracting system.

### BACKGROUND OF THE INVENTION

The present invention relates to an Internet camera system including an Internet camera and a plurality of clients for viewing images captured by the Internet camera.

Recently, the Internet is widely used for various purposes. In the U.S. patent application Ser. No. 09/204,289, an Internet camera, which is capable of capturing images, and uploading image files containing the captured images to a predetermined server on the Internet, is described.

The conventional Internet camera is configured such that the camera is oriented to a predetermined direction and captures an image within a predetermined area.

It may be possible to use a camera, which is controlled through the Internet to change directions and/or to perform zooming. However, such a camera requires a moving mechanism for changing the orientation of the camera and/or moving the zoom lens provided thereto. Further, in order to enable the remote control of such mechanisms, the camera is required to have a server function and should be always connected to the Internet so that a user can control the camera at any desired time. As above, in order to meet the demand, the manufacturing cost and the running cost increase. Furthermore, even if the camera system is configured as described above, only one of the users can control the camera at a time. That is, if the camera is being controlled, another user cannot control the camera as far as the camera is in the “busy” status.

### SUMMARY OF THE INVENTION

It is therefore an object of the invention to provide an improved Internet camera system with which each of a plurality of users at respective clients can view desired parts of images captured by an Internet camera at desired time.

For the object, according to the present invention, there is provided an Internet camera system that is provided with an Internet camera and a plurality of clients, each of which are connectable to a predetermined server on the Internet. The Internet camera includes an image capturing system that captures an image covering a relatively wide area, and a transmitting system that transmits the captured image to the server on the Internet. Each of the plurality of clients includes a downloading system that downloads the image from the predetermined server, a storage device that stored the downloaded image, an extracting system that extracts a desired part of the image stored in the storage device, and a display system that displays the part of the image extracted by the extracting system.

With the above configuration, each of a plurality of users at respective clients can view desired parts of images captured by an Internet camera at desired time.

Optionally, the Internet camera may include a camera employing a fish-eye lens, and in this case, the display system may compensate for distortion of the image captured through the fish-eye lens.

Further optionally, the extracting system may enable a user of each of the plurality of clients to scroll the image displayed by the display system.

Optionally or alternatively, the extracting system may enable a user of each of the plurality of clients to perform zooming of the image displayed by the display system.

Optionally or alternatively, the extracting system may enable a user of each of the plurality of clients to rotate the image displayed by the display system.

### DESCRIPTION OF THE ACCOMPANYING DRAWINGS

FIG. 1 schematically shows a configuration of an Internet camera system according to an embodiment of the invention;

FIG. 2 is a block diagram illustrating main components of an Internet camera;

FIG. 3 is a block diagram illustrating main components of a client;

FIG. 4 illustrates an image captured by an Internet camera of the Internet camera system;

FIG. 5 shows an image on a display of a client when a viewer program is launched;

FIGS. 6A-6C dialog boxes for setting scroll, zoom and rotation parameters, respectively.

### DESCRIPTION OF THE EMBODIMENT

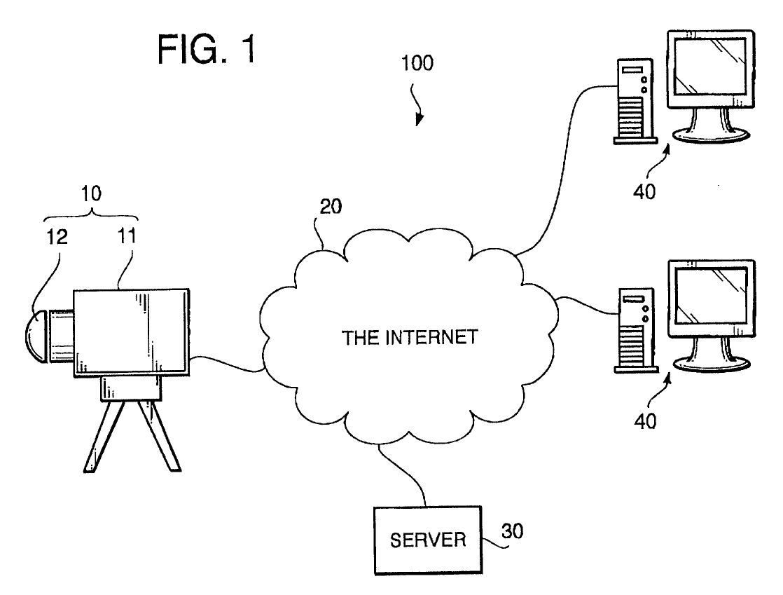

FIG. 1 schematically shows a configuration of an Internet camera system 100 according to an embodiment of the invention. The Internet camera system 100 includes an Internet camera 10, a server 30 and a plurality of clients 40 to be connected to the server 30 through the Internet. The Internet camera 10 is also connectable to the server 30 through the Internet 20.

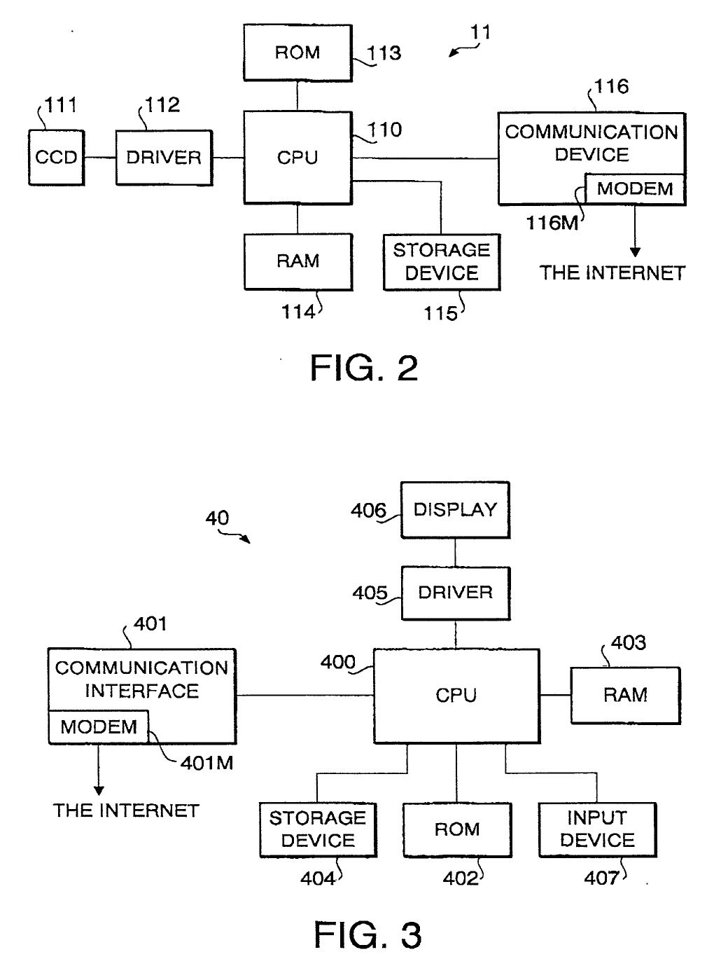

FIG. 2 schematically shows a configuration of the Internet camera 10 according to the embodiment of the invention. The Internet camera 10 includes a camera body 11 on which a fish-eye lens 12 is mounted (see FIG. 1). The angle of field of the fish-eye lens 12 is approximately 180 degrees. As shown in FIG. 2, the body 11 accommodates a CPU 110, a ROM 113, a RAM 114, a CCD 111 and a CCD driver 112. The ROM 113 stores programs for controlling the Internet camera 10, and the CPU 110 controls the operation of the Internet camera 10 in accordance with the programs stored in the ROM 113. The RAM 114 temporarily stores various data for operation. An image capturing and transmitting schedule is stored in a memory (not shown), such as an EEPROM. The CCD 11 captures an image through the fish-eye lens 12 in accordance with the schedule stored in the memory, generates image data representing the captured image. The CPU 110 compresses the image data, and stores the image data in a storage device 115. Since the angle of field of the fish-eye lens is approximately 180 degrees, although the image captured by the CCD 111 is distorted, the image covers a significantly wide area, which cannot be captured by normal cameras.

The image data stored in the storage device 115 is transmitted (uploaded) to the server 30 through a communication device 116 in accordance the schedule stored in the memory. In this embodiment, the communication device 116 include a modem 116M, and the Internet camera 10 is connected to the server 30 using a dial-up connection. An example of such an Internet camera is described in the afore-mentioned U.S. patent application Ser. No. 09/204,289, teachings of which are incorporated herein by reference.

Each of the clients 40 is connectable to the server 30 through the Internet 20, using the dial-up connection.

It should be noted that the Internet camera 10 may be configured to be always connected to the Internet 20. Similarly, some or all of the clients 40 may be always connected to the Internet 20 through a lease line.

FIG. 3 shows a configuration of a client 40. All the clients 40 have the similar configuration. The client 40 is provided with a CPU 400 that controls an entire operation of the client 40. The client 40 further includes a communication interface 401 including a modem 401M, a ROM 402 storing programs to be executed by the CPU 400, a RAM 403 used for temporarily storing various data. The CPU 400 is further connected with a display 406 through a display driver 405, an input device 407 including a keyboard and a mouse, and a storage device 404 used for storing image data downloaded from the server 30.

In each client 40, a browsing program and a viewer program are pre-installed (e.g., stored in the ROM 402 and/or on a not-shown hard disk). An example of the viewer program is described in U.S. Pat. No. 5,796,426, teachings of which are incorporated herein by reference in its entirety.

It should be noted that the viewer program is required to be executed in association with the browsing software so that the image can be viewed therethrough when a user accesses the server 30 with the browsing program. Alternatively, the viewer program may have a function of the browsing program. In the following description, it is assumed that the viewer program is automatically launched when it becomes necessary to use the same while the user accesses the server 30 with the browsing program.

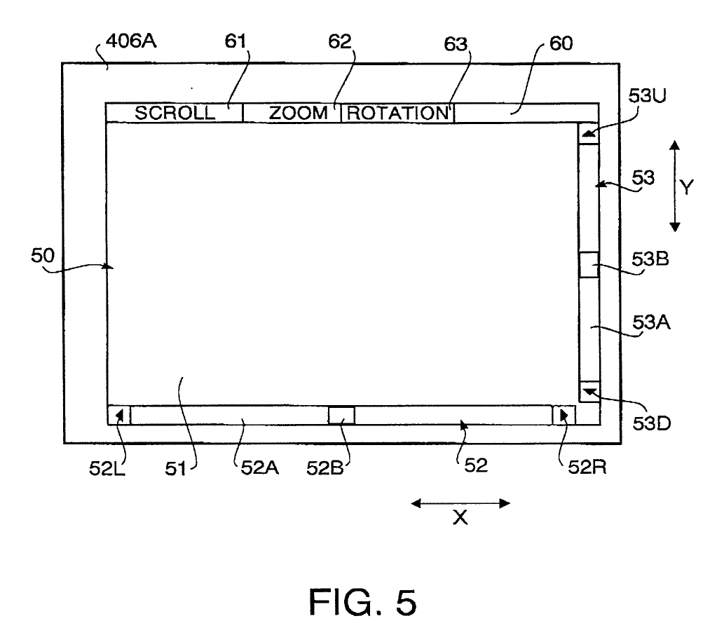

Firstly, the user makes a dial-up connection to connect the client 40 with the Internet 20 through the modem 401M. Then, the user launches the browsing program and accesses the server 30. When the client 40 is connected to the server 30, and upon a predetermined operation (e.g., a click using the mouse) performed by the user, the browsing software downloads image data containing the entire image captured by the Internet camera 10 from the server 30. The downloaded image data is stored in the storage device 404. Further, the stored image data is loaded to the RAM 403. Simultaneously with the download of the image data from the server 30, the viewer program is launched automatically. The viewer program applies compensation to part of the image data, which has been stored in RAM 403, corresponding to a predetermined portion within the captured image. For example, the central portion of the entire image is compensated and displayed in a viewer window 50 (see FIG. 5), which is opened by the viewer program on the display screen 406A of the display 406.

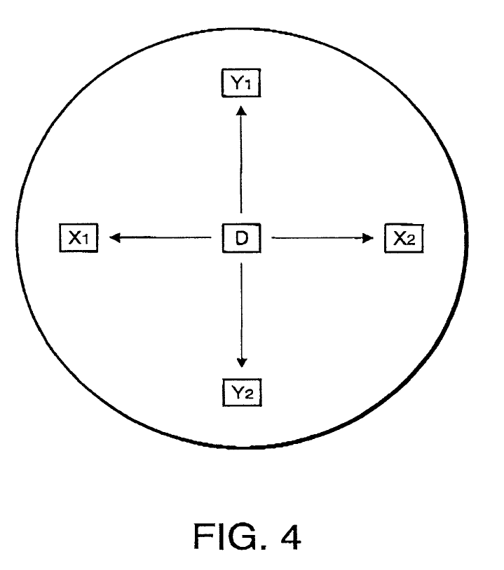

FIG. 4 shows a relationship between the image displayed on the viewing window 51 of the viewer window 50 (see FIG. 5), which is displayed on the display screen 406A, and the entire image captured by the Internet camera 10. In FIG. 4, a rectangle D indicates the portion that is initially displayed in the viewing window 51. That is, distortion of the image at portion D of the image is compensated, and then the compensated image is displayed on the viewing window 51.

As shown in FIG. 5, on the viewer window 50, which is opened on the display screen 406A, an X scroll bar 52, and a Y scroll bar 53 are displayed. Further, a menu bar 60 is provided on an upper side of the viewer window 50. Thus, the viewing window 51 is surrounded by the X scroll bar 52, Y scroll bar 53 and the menu bar 60.

At the ends of the X scroll bar 52, arrow buttons 52L and 52R area provided. At the ends of the Y scroll bar 53, arrow buttons 53U and 53D are provided. The user can move the X and/or Y scroll button 52B and 53B by clicking the arrow buttons 52R, 52L, 53U and 53D. The X and Y scroll buttons 52B and 53B can also be moved by clicking portions 52A and 53A, on the scroll bars 52 and 53, between an arrow button 52R, 52L, 53U or 53D, and the scroll button 52B or 53B, or by directly dragging the scroll button 52B or 53B. Since such an interface is well-known and widely used in the field of computer, detailed description will not be provided.

For example, when the portion D (see FIG. 4) is displayed, by moving the X scroll button 52B, the displayed portion can be shifted from portion D toward portion X1 or X2. If the Y scroll button 53B is moved when the portion D is displayed, the displayed portion is shifted toward portion Y1 or Y2. Thus, by moving the X and Y scroll buttons 52B and 53B, any portion within the entire image captured by the Internet camera 10 can be selected and displayed in the viewer window 50. It should be noted that the viewer program applies appropriate compensation to any one of the selected image so that the distortion thereof is compensated.

Further to the above, it is also possible to perform scrolling, zooming and/or rotation of the displayed image by a predetermined key operation.

Optionally or alternatively, scroll, zoom and rotation operations can also be done using dialog boxes, which are displayed by selecting respective menus on the menu bar 60.

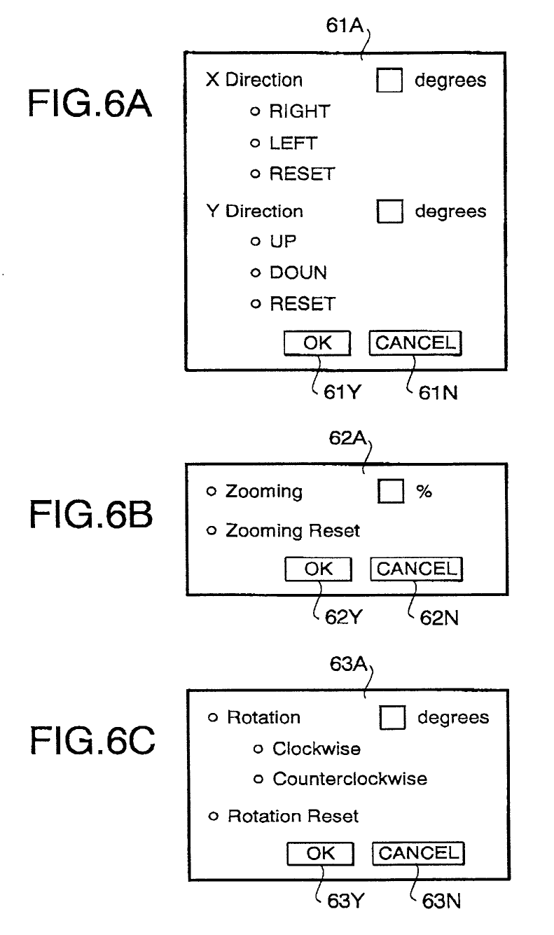

FIGS. 6A-6C show examples of dialog boxes 61A, 62A and 63A, which are displayed in the display window 50 when the “SCROLL”, “ZOOM” and “ROTATION” menus 61, 62 and 63 are clicked, respectively.

When “SCROLL” 61 on the menu bar 60 is clicked, a scroll setting dialog box 61A is dlsplayed (FIG. 6A). The user can input a designated position by angles, with respect to the portion D, in the X and/or Y directions, or reset the scrolling status in the X and/or Y directions. After inputting/selecting the setting in the dialog box 61A, by clicking an “OK” button 61Y, the setting is effected, and the dialog box 61A disappears. If a “CANCEL” button 61N is clicked, the input setting is cancelled, and the dialog box 61A disappears.

When “ZOOM” 62 on the menu bar 60 is clicked, a zoom setting dialog box 62A is displayed. The user can input a zooming ratio with respect to the presently displayed image, or reset the zooming status. After inputting/selecting the setting in the dialog box 62A, by clicking an “OK” button 62Y, the setting is effected, and the dialog box 62A disappears. If a “CANCEL” button 62N is clicked, the input setting is cancelled, and the dialog box 62A disappears.

When “ROTATION” 63 on the menu bar 60 is clicked, a rotation setting dialog box 63A is displayed. The user can input a rotation angle with respect to the presently displayed image or reset the rotation status. After inputting/selecting the setting in the dialog box 63A, by clicking an “OK” button 63Y, the setting is effected, and the dialog box 63A disappears. If a “CANCEL” button 63N is clicked, the input setting is cancelled, and the dialog box 63A disappears.

As above, according to the Internet camera system described above, once the entire image captured by the Internet camera is downloaded and stored in the storage device of each client, a user at each client can view an image as if the Internet camera is controlled thereby. Therefore, the client is not necessary to be always connected to the Internet, which reduces the communication cost. Further, the client does not send any command to the Internet camera. Therefore, the camera is not occupied by a certain client. Accordingly, all the clients are capable of viewing an image with the scroll, zoom and rotation effects remained effective.

In the Internet camera according to the embodiment, a fish-eye lens is used. It is known that the depth of field of the fish-eye lens is very deep. Accordingly, any portion of the image captured by the Internet camera is substantially focused. Therefore, an automatic focusing mechanism needs not be provided to the Internet camera.

In the Internet camera described above, a fish-eye lens is employed. However, the invention is not limited to this structure, and another type of lens may be employed if it views a relatively wide area.

Purther, in the above-described embodiment, the camera captures and transmits a still image in accordance with a schedule. However, the invention is not limited to this configuration, and animated image may be transmitted to the server, and viewer software capable of reproducing the animated image may be provided to each client.

The present disclosure relates to the subject matter contained in Japanese Patent Application No. 2000-049250, filed on Feb. 25, 2000, which is expressly incorporated herein by reference in its entirety.

What is claimed is:

1. An Internet camera system, comprising:
an Internet camera including an image capturing system that captures an image covering a relatively wide area, and a transmitting system that transmits the captured image to a predetermined server on the Internet; and
a plurality of clients, each of which includes a downloading system that downloads the image from said predetermined server, a storage device that stored the downloaded image, an extracting system that extracts a desired part of the image stored in said storage device, and a display system that displays the part of the image extracted by said extracting system.

2. The Internet camera system according to claim 1, wherein said Internet camera includes a camera employing a fish-eye lens, and wherein said display system compensates for distortion of the image captured through said fish-eye lens.

3. The Internet camera according to claim 1, wherein said extracting system enables a user of each of said plurality of clients to scroll the image displayed by said display system.

4. The Internet camera according to claim 1, wherein said extracting system enables a user of each of said plurality of clients to perform zoomIng of the image displayed by said display system.

5. The Internet camera according to claim 1, wherein said extracting system enables a user of each of said plurality of clients to rotate the image displayed by said display system.
